(19) United States
(12) Patent Application Publication
(10) Pub. No.: US 2004/0258360 A1
(43) Pub. Date: Dec. 23, 2004

(54) External gain element with mode converter and high index contrast waveguide

(76) Inventors: Desmond R. Lim, Singapore (SG); Dong Pan, Andover, MA (US); Christian Hoepfner, North Andover, MA (US); Wang-Yuhl Oh, Cambridge, MA (US); Kevin Kidoo Lee, Cambridge, MA (US)

Correspondence Address: EDWARDS & ANGELL, LLP, P.O. BOX 55874, BOSTON, MA, 02205, US

(21) Appl. No.: 10/809,735

(22) Filed: Mar. 25, 2004

Related U.S. Application Data
(60) Provisional application No. 60/457,229, filed on Mar. 25, 2003.
(60) Provisional application No. 60/470,305, filed on May 14, 2003.

(51) Int. Cl. G02B 6/26

(52) U.S. Cl. 385/43; 385/28

(57) ABSTRACT

An external gain system includes a gain source, a laser coupler, one or more mode converters, a high index contrast waveguide, and a filter structure fabricated on either high or low index contrast waveguides. The filter structure defines the external cavity with the front facet of the laser diode. An external cavity laser is further integrated with one or more functional blocks to perform a specific function. A multiplexer is integrated with the external cavity laser array, where the waveguide ends of the external cavity serve as an input to the multiplexer, to form an integrated WDM transmitter. The output of the transmitter, if fabricated on high index contrast waveguide, is then coupled to a low index waveguide or fiber matched waveguide by using a mode converter. The gain system can be configured to become a linear optical amplifier and can also be configured as a low cost wavelength converter.

### CROSS REFERENCE TO RELATED APPLICATIONS

This application claims priority from U.S. provisional patent application No. 60/457,229, filed Mar. 25, 2003, entitled LOW COST SINGLE MODE EXTERNAL CAVITY LASER SYSTEM WITH MODE CONVERTER AND HIGH INDEX CONTRAST WAVEGUIDE and U.S. provisional patent application No. 60/470,305, filed May 14,2003, entitled EXTERNAL CAVITY LASER WITH MODE CONVERTER AND HIGH INDEX CONTRAST WAVEGUIDE AND INTEGRATED WDM TRANSMITTER.

### BACKGROUND

A single mode laser generating a 1.3 um and 1.5 um wavelength signal is one of the most important components in communication systems. Distributed Feedback (DFB) lasers are the most common light source to achieve single mode operation for telecommunications. This type of device has been dominant in the market over 20 years. However, it suffers from a low yield due to manufacturing difficulties because of material overgrowth and double modes in the wavelength spectrum. As a result, the DFB is still expensive to manufacture. Another method for generating single mode signals is to use a Vertical Cavity Surface Emitting Laser (VCSEL), but currently there is no commercially available VCSEL for the desired telecommunication wavelengths at 1.3 um and 1.5 um. Furthermore, both DFBs and VCSELs are standalone devices, and additional packaging is required to integrate these lasers in a system. Packaging adds additional cost in both time and material because laser coupling in telecommunication devices requires active alignment of the laser source and downstream system with very small tolerance.

External Cavity Lasers (ECL) can provide a low cost solution. Generally, an ECL consists of a laser source and an external reflector in order to form a cavity. It is an effective low cost solution. A grating is made on a fiber or waveguide and usually acts as an external mirror to the light source. However, ECLs suffer from mode hopping and coupling loss.

Both fiber and waveguide grating configurations, as used in ECLs, are considered low index contrast systems. A fiber inherently has a very low index contrast between the core and the surrounding cladding material, and a low index contrast system (e.g., using either fiber grating or waveguide grating) has several limitations and disadvantages. First, with fiber gratings, device size is typically large because a fiber grating is at least on the order of 4-8 mm range. This size component is an inefficient use of real estate in ever increasingly smaller telecommunications components. Second, in order to make a laser array, the same number of fiber is required as the number of lasers, which can be large in size and costly in active alignment between laser and fiber. Third, there is no effective way to put more function blocks on fiber.

In the case of a low index contrast waveguide grating, the coupling efficiency between laser and low index contrast waveguide is not high enough and causes loss in the cavity (e.g., some commercial waveguides exhibit up to 6 dB loss). This low coupling efficiency limits the frequency performance of the laser because of the reflection at the lossy interference between the laser and low index contrast waveguide. Another drawback of the waveguide grating is that it requires a specific laser, such as spot size converter laser that adds more cost. In addition, waveguide gratings, formed by UV writing for such materials as germanium doped waveguides, limits the design flexibility and fabrication. Finally, the low index contrast waveguide is limited in providing multi-functions because of large size of the device due to large minimum bending radius that approach millimeters or centimeters in scale; again, too large to be practicable.

### SUMMARY OF THE INVENTION

An external gain system includes a laser diode or gain source, a laser coupler, one or more mode converters, a high index contrast waveguide, and a filter structure fabricated on either high or low index contrast waveguides. The laser coupler formed on the high index contrast waveguide provides high coupling efficiency from the laser or gain medium to the high index waveguide, and the mode converters are used to provide high coupling efficiency from the high index contrast waveguide to fiber or fiber matched low index contrast waveguide. The filter structure defines the external cavity with the front facet of the laser diode. The filter structures may be a grating or ring resonator with micron-sized bends.

Utilizing an external cavity laser in accordance with the invention, an integrated wavelength division multiplexer (WDM) transmitter may be formed. The integrated WDM transmitter may be made from one or more laser diode arrays optically coupled to waveguide arrays, each function as a filter, to form the external cavity laser array. In one preferred embodiment, laser diode arrays can be fabricated using III-V materials and integrated with waveguides formed of silicon. Multiplexers such as echelle grating or Array Waveguide Grating (AWG), by way of non-limiting example, can be integrally formed with the waveguide arrays.

In one embodiment, the multiplexer is fabricated on a high index contrast waveguide, and the output of the multiplexer can be coupled to a plurality of low index waveguides or fiber matched waveguides using a mode converter, and further coupled to a fiber. In another embodiment, the multiplexer is fabricated on a low index contrast waveguide where the input waveguides to the multiplexer are fabricated on high index contrast waveguides and coupled to the multiplexer by using mode converters.

With the above mentioned efficient hybrid integration of a conventional semiconductor gain element and the high index contrast waveguide circuit by using the same mode converter technology, a low cost linear optical amplification solution is provided. The invention may be used to provide gain clamped optical amplifiers having constant gain under the input power and number of input WDM channel variation and the ability to make linear optical amplifiers providing great flexibility and reliability to the optical network.

### BRIEF DESCRIPTION OF THE DRAWINGS

For a fuller understanding of the invention, reference is had to the following description taken in connection with the accompanying drawings in which:

FIG. 1 is a schematic top plan view of an external gain element system with high index contrast waveguides constructed in accordance with the invention;

FIG. 2A is a top plan schematic view of a general configuration of an external cavity laser with a grating formed on high index waveguide in accordance with the invention;

FIG. 2B is a top plan schematic view of an external cavity laser with a grating formed on a low index waveguide in accordance with the invention;

FIG. 3 shows a top plan view of coupling a laser diode with a laser matched high index waveguide in accordance with the invention;

FIG. 4 is a top plan view of coupling a laser diode with a tapered waveguide in accordance with another embodiment of the invention;

FIG. 5 is a top plan view of an external cavity laser configuration with ring resonators in accordance with another embodiment of the invention;

FIG. 6 is a top plan view of an external cavity laser utilizing coupled ring resonators as filters in accordance with yet another embodiment of the invention;

FIG. 7 is a top plan view of an external cavity laser utilizing coupled ring resonators as filters in accordance with yet another embodiment of the invention;

FIG. 8 is a cross sectional view of deep etch grating on low index contrast waveguide in accordance with the invention;

FIG. 9A is a top sectional view of a high index contrast waveguide showing a grating etched on the side of the waveguide core in accordance with the invention;

FIG. 9B is a side sectional view of a high index contrast waveguide showing a grating etched on the top of the waveguide core in accordance with another embodiment of the invention;

FIG. 10 is a top plan view of an external cavity laser configuration with laser matched high index contrast waveguide, a mode converter, and grating on low index contrast waveguide in accordance with another embodiment of the invention;

FIG. 11 is a top plan view of a tunable external cavity laser with heating element on the region of a ring resonator filter in accordance with another embodiment of the invention;

FIG. 12 is a top plan view of an external cavity laser array integrated with a multiplexer fabricated on the high index contrast waveguide to form an integrated WDM transmitter in accordance with the invention;

FIG. 13 is a top plan view of an external cavity laser array integrated with a multiplexer fabricated on a low index contrast waveguide to form an integrated WDM transmitter in accordance with still another embodiment of the invention;

FIG. 14 is a top plan view of an external cavity laser array integrated with a multiplexer in accordance with still another embodiment of the invention,

FIG. 15 is a top plan view of an external cavity laser array integrated with a multiplexer in accordance with still another embodiment of the invention;

FIG. 16 is a top plan view of an external cavity laser array formed of ring resonators integrated with a multiplexer in accordance with still another embodiment of the invention;

FIG. 17 is a schematic top plan view of a tunable external cavity laser utilizing a heating element constructed in accordance with yet another embodiment of the invention;

FIG. 18 is a schematic plan view of multiple lasers, external cavity systems, and output fibers where the grating is slightly different for each device in accordance with yet another embodiment of the invention;

FIG. 19 is a schematic top plan view of a gain clamped linear optical amplifier constructed in accordance with the invention;

FIG. 20 is a schematic top plan view of a gain clamped linear optical amplifier with ring filters as narrow band filters constructed in accordance with the invention;

FIG. 21 is a schematic top plan view of a gain clamped linear optical amplifier with higher order ring filters as narrow band filters constructed in accordance with another embodiment of the invention;

FIG. 22 is a schematic top plan view of a gain clamped linear optical amplifier with narrow band filters constructed in accordance with another embodiment of the invention;

FIG. 23 is a schematic top plan view of a gain clamped linear optical amplifier with narrow band filters constructed in accordance with another embodiment of the invention;

FIG. 24 is a schematic top plan view of a gain clamped linear optical amplifier with waveguide gratings constructed in accordance with another embodiment of the invention;

FIG. 25 is a schematic top plan view of a gain clamped linear optical amplifier with a Silicon Optical Amplifier having a mirror at one side and a narrow band 4 port filter and waveguide grating constructed in accordance with another embodiment of the invention;

FIG. 26 is a schematic top plan view of a gain clamped linear optical amplifier with a Silicon Optical Amplifier having a mirror at one side, and a waveguide grating and an additional narrow band filter constructed in accordance with another embodiment of the invention;

FIG. 27 is a schematic top plan view of a gain clamped linear optical amplifier with a Silicon Optical Amplifier having both input and output ports on the same facet constructed in accordance with the invention;

FIG. 28 is a schematic top plan view of a wavelength converter constructed in accordance with another embodiment of the invention;

FIG. 29 is a schematic top plan view of a wavelength converter utilizing a local cw input light as the light of target wavelength in accordance with another embodiment of the invention;

FIG. 30 is a schematic top plan view of a wavelength converter constructed in accordance with another embodiment of the invention; and

FIG. 31 is a schematic top plan view of a wavelength converter constructed in accordance with another embodiment of the invention.

### DETAILED DESCRIPTION OF THE INVENTION

This invention provides for an external gain system including a laser diode or gain source, a laser coupler, one or more mode converters, and high index contrast waveguide, and a filter structure fabricated on either high or low index contrast waveguides.

In contrast to regular fiber or fiber matched waveguide where the index contrast is approximately 0, the high index contrast waveguide defined in this invention has an index contrast of up to around 0.6. The high index contrast waveguide provides the following unique advantages: (1) high efficiency coupling between the laser/gain source and waveguide, and (2) ease of integration of additional functions such as ring resonator and micron-size bends for filter functions.

As used throughout this specification, a “High Index Contrast Waveguide” (HIC-WG) is a waveguide where delta (Δ) as defined below in a channel waveguide embodiment is at least 0.1 (or at least 0.2 or 0.3 in other embodiments):

$$Δ = \frac{{n}_{2} - {n}_{3}}{{n}_{3}} \geq 0.1$$

where n₂ is the index of refraction of the core material and n₃ is the index of the refraction of the cladding material. Other types of waveguides, such as rib waveguides, can also be used for high index contrast waveguides.

It should be noted that terms such as waveguide and fiber are used interchangeably, however, waveguide means any structure capable of receiving an input of a light signal and providing an output of a light signal. Similarly, the term gain source and laser are used interchangeably, however, gain source, although including lasers, means any light source capable of outputting a light signal in response to a power input.

As used throughout this specification, a “low index contrast waveguide” is a waveguide that has a mode field size similar to that of an external fiber. For a channel waveguide embodiment, for example, such a low index difference waveguide is a waveguide where Δ is less than 0.1. Other types of waveguides aside from channel waveguides, however, can be used as low index difference waveguides if the mode field size is similar. In preferred embodiments, except for the gain medium element, all functionalities or functional blocks including waveguides of the invention are implemented on a Si-wafer that can be fabricated with CMOS compatible processes; leveraging of the CMOS processing capability allows for the low cost amplification solution for an optical integrated circuit.

The core of the high index contrast waveguide can be SiN or SiON, by way of non-limiting example, and the surrounding cladding materials can be such as SiO₂. However, other material systems of silicon or silica based, organic/inorganic/polymer based, or III-V material based can be utilized without deviating from the spirit of this invention. The high index contrast waveguide enables an integration of additional functions such as a ring resonator using micron-size bends and also provides an efficient way to couple the semiconductor laser.

One embodiment of the invention is a use of silicon oxynitride, SiOₓN₁₋ₓ, high index contrast waveguide. SiOₓN₁₋ₓ can be deposited by the PECVD or LPCVD processes. When X=0, the material is SiN with the refractive index of around 2.1, while when X=1, the SiO has refractive index of around 1.45. By changing the composition of N, the index of SiON can be varied from 1.45 to 2.1. It provides great flexibility for design and manufacturing. For example, any index contrast can be set by choosing a particular percentage of N. Since a regular edge-emitting laser generally has a larger mode size with corresponding effective index contrast, the same index contrast waveguide as the laser can be made by carefully choosing the index contrast and the waveguide dimension to achieve high coupling efficiency. As noted, using a high index contrast waveguide provides a way to make efficient coupling and high quality filter structures.

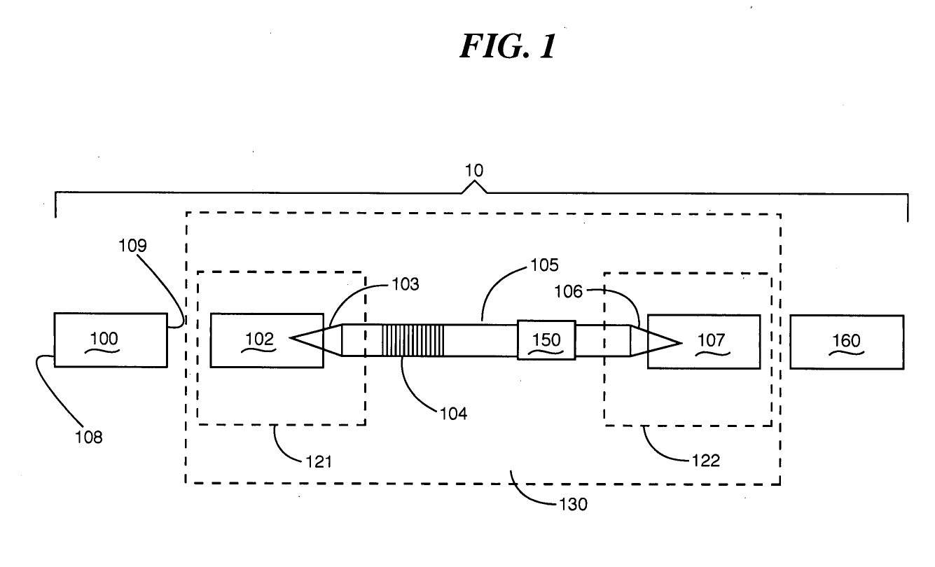

Reference is first made to FIG. 1 in which a schematic plan view of an external gain element system, generally indicated as 10, is provided. System 10 includes a gain element 100, a high index contrast waveguide system 130, and an external fiber 160. High index contrast system 130 includes two mode converters 121 and 122 that are used to couple light from a low index waveguide 102, 107 to a high index waveguide 105 and vice versa. A high index waveguide 105 with grating structure 104 formed thereon optically couples mode converters 121, 122 to each other. The optical couple occurs at opposed respective tapered optical couplers 103, 106. An optional functionality generically shown as block 150 may be provided on HIC WG 105.

During operation, a light signal generated by gain element 100 is coupled to low index waveguide 102 and coupled to high index waveguide 105 through a mode converter 121. The light signal, refined in the grating cavity that is described in detail below, goes through function block 150 and another mode converter 122 to low index waveguide 107 before being coupled into an external fiber 160. The use of mode converter 122 is for the better coupling efficiency between waveguide 107 and a fiber 160.

By way of non-limiting example, gain element 100 may be a diode gain element. Generally, a diode gain element provides gain medium for forming an external cavity. Gain element 100 has two semiconductor air facets 108, 109. In order to form the external cavity with grating reflector 104, front facet 108 of gain element 100 can be coated to enhance the reflectivity, and opposing facet 109 can be Anti-Reflection (AR) coated to eliminate the internal laser diode cavity, which may be formed as result of reflections. After facets 108, 109 of gain element 100 are properly coated, the diode functions as gain medium with one facet as a mirror. The invention described here is not limited to Fabry-Perot gain elements, and other laser/gain elements types, such as tapered laser or spot size mode converter, can be used in the external cavity laser system.

The light from the AR-coated facet 109 of the gain element needs to be coupled into waveguide system 130. The coupling efficiency between the gain element and waveguide is usually a big issue. The coupling loss is required to be very small. The coupling loss mainly comes from the following facts: edge emitting semiconductor gain elements have two different divergence angles at horizontal and vertical direction, and the numerical aperture of the laser light is larger than fiber. It is known in the art to use a tapered fiber to couple the light into the fiber and therefore is not discussed here.

The index contrast for the input waveguide 102 may be chosen to match the corresponding effective index contrast of gain element, which will greatly reduce the coupling loss between the gain element 100 and waveguide 102. Another advantage of using waveguide coupling rather than fiber coupling is that the cross section of the input waveguide 102 may also be matched to the mode profile of the mode field of the laser light. For example, the height and width of the waveguide can be varied to match the input laser light. By this way, the coupling loss between the waveguide system and the laser is dramatically reduced.

The gain medium is a separate element that is hybrid integrated with an external cavity element, and the integrated structure forms the ECL structure. In one embodiment, the gain medium is based on the III-V semiconductor material, and the external cavity element is based on silicon substrate or silicon-based materials. Thus, the III-V material based gain medium element and silicon-based element are hybrid integrated to form the present invention. As is known in the semiconductor art, these elements may be formed as chips.

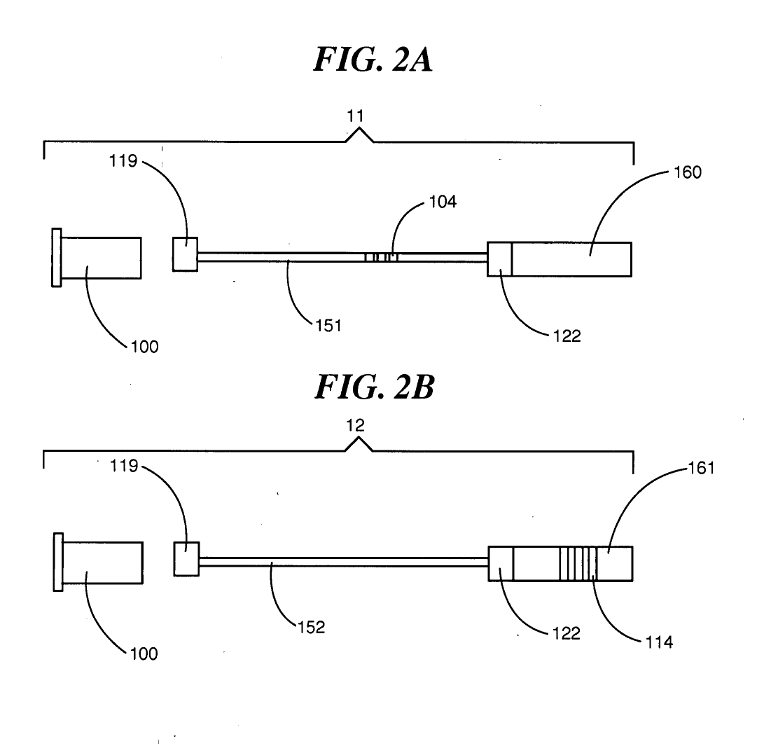

Reference is now made to FIGS. 2A and 2B where general configuration of a specific embodiment of the external gain element system is depicted. Like numbers are utilized to identify like structure. System 11 includes a laser or gain source 100, a laser coupler 119, a high index contrast waveguide 151, a filter structure such as grating 104 formed on waveguide 151, mode converter 122, and low index contrast waveguide 160 coupled to a high index contrast waveguide 160 through mode converter 122. The primary difference in this embodiment being the use of a laser coupler as opposed to a mode converter and removal of additional functionality from the HIC waveguide. In system 11, grating 104 defines the external cavity, which is again formed on high index contrast waveguide 151. However, in another embodiment, as shown in FIG. 2A, again like numbers are used to depict like structures, the grating is formed on the low index contrast waveguide as shown. The system includes gain source 100, laser coupler 119, HIC waveguide 152 and mode converter 122. Low index waveguide 161 optically coupled by mode converter 122 to HIC waveguide 152 includes grating 114 formed thereon. The grating in both embodiments 11 and 12 defines the external cavity with the front facet of laser diode 100. It is noted that a ring resonator may be substituted for the grating to provide the same function as the grating. Grating or ring resonator diameter size determines or selects different wavelength to be reflected.

One laser coupler defined in this invention is the one, which couples the laser source into a waveguide with high coupling efficiency. It is noted that the laser source, which is used in the external cavity laser usually has an Anti-Reflection (AR) coating on one side. Thus, it is technically not a laser any more after the AR coating; it is in fact a gain medium or gain source. Therefore, laser coupler in this invention indicates the high efficiency coupling structure between the gain source and waveguide.

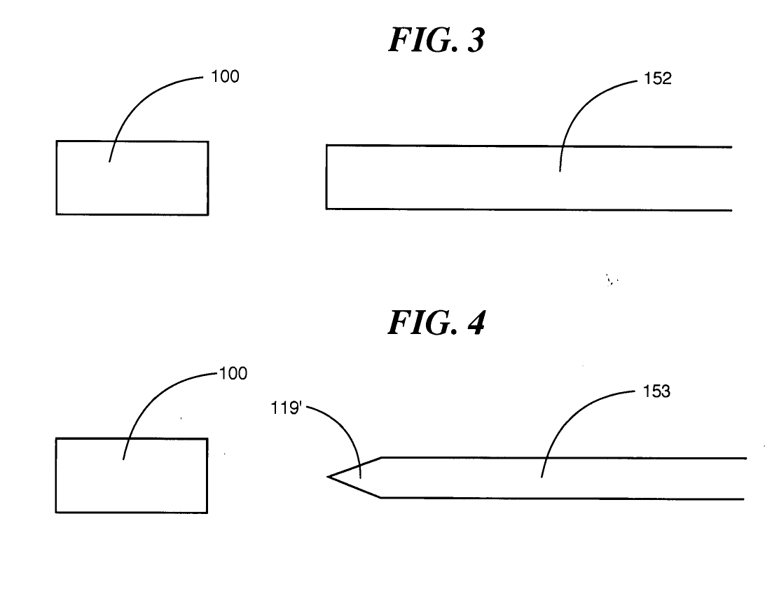

As mentioned before, the index contrast in the coupler can be chosen to match the index contrast of the gain source for high efficiency coupling, as shown in FIG. 3. In FIG. 3, the index contrast of a high index waveguide 152 can be matched to gain source 100. In another embodiment, as shown in FIG. 4, a very high index waveguide 153 such as 0.6 index contrast is tapered at a taper 119 at the receiver end of the waveguide; the taper further acting as the laser coupler element. Tapered tip 119 reduces the effective index of the high index waveguide to match the effective index in gain element 100, such as a laser diode, by way of example, by controlling the tip width. The tapered end can be set at the edge of the tip or be embedded in some form of cladding material. The optimal geometry of the tapered end and its relative position from the edge of a chip depends on the exact geometry of the waveguide, the divergence of the gain element and any adhesive that intervenes between the gain element and the high index contrast waveguide, and can be determined by known beam propagation methods. The taper may be adiabatic or linear.

The use of mode converters such as mode converters 121, 122 provides high coupling efficiency between a fiber or a fiber matched low index waveguide and high index contrast waveguide. Mode converters are known from U.S. Pat. Nos. 09/841,464 and 09/978,310 and are incorporated herein as if fully set forth. The mode converter functions to couple the laser light out into fiber or fiber matched waveguide from high index contrast waveguides or vice versa.

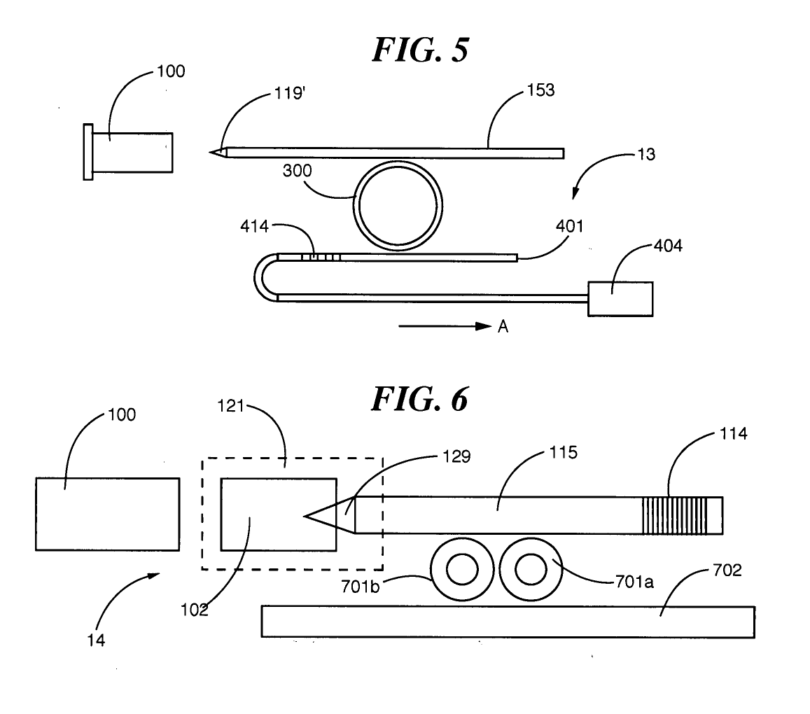

Reference is now made to FIG. 5, in which another embodiment of the invention using ring resonators and gratings as filters is provided. Due to smaller waveguide geometry of high index contrast waveguide compared to typical geometry of low index contrast waveguide, ring resonators are more suitable to be fabricated together with the high index contrast waveguide because a ring resonator has high fabrication constraint, especially in etching of the waveguide. FIG. 5 shows an ECL generally indicated as 13 formed with a ring resonator 300 as a filter where a particular wavelength determined by the diameter of the ring resonator is transmitted to waveguide 401. More specifically, system 13 includes a gain source 100 such as a laser as described above which is optically coupled to an HIC waveguide 153 having a tapered end as a labored laser coupler structure 119′. A ring resonator 300 acting as a filter optically couples HIC waveguide 153 to waveguide 401. A grating 414 is formed along waveguide 401. A mode converter 404 is either formed with, or disposed at, waveguide 401 along the light path indicated by arrow A.

Grating 414, downstream of ring resonator 300, acts as a reflector to form an external cavity through waveguide 401, ring resonator 300, high index contrast waveguide 153, laser coupler 119′, and laser/gain source 100. Light eventually exits ECL 13 through mode converter 404 to a fiber (not shown).

It is then possible to make a narrow line width laser, where the ring resonators are introduced in the cavity. A very narrow band filter is introduced into in the cavity because ring resonators can provide high Q and therefore extremely narrow line width. In particular, in an embodiment in which ring resonator 300 is made on the Si based high index contrast waveguide, the quality can be very high because of the mature Si technology.

Reference is now made to FIG. 6 in which another embodiment of the invention identified as system 14 is provided. Like numerals are used to indicate like structure. A laser diode gain medium 100 is optically coupled to a mode converter 121 having a low index waveguide 102. A tapered optical coupler 129 is formed at a receiving end of a HIC waveguide 115. A grating 114 is formed on HIC waveguide 115. A waveguide 702 is optically coupled to HIC waveguide 115 by resonators 701a, 701b. Resonators 701b and 701a may be tuned to different resonant frequencies to act as filters. During operation, a light signal traveling along HIC waveguide 115 is coupled into one of ring resonators 701a, 701b and then coupled out into another straight waveguide 702. By utilizing multiple coupled ring resonators, the line width can be made even narrower (e.g., two ring resonators placed close to each other) as compared to system 13.

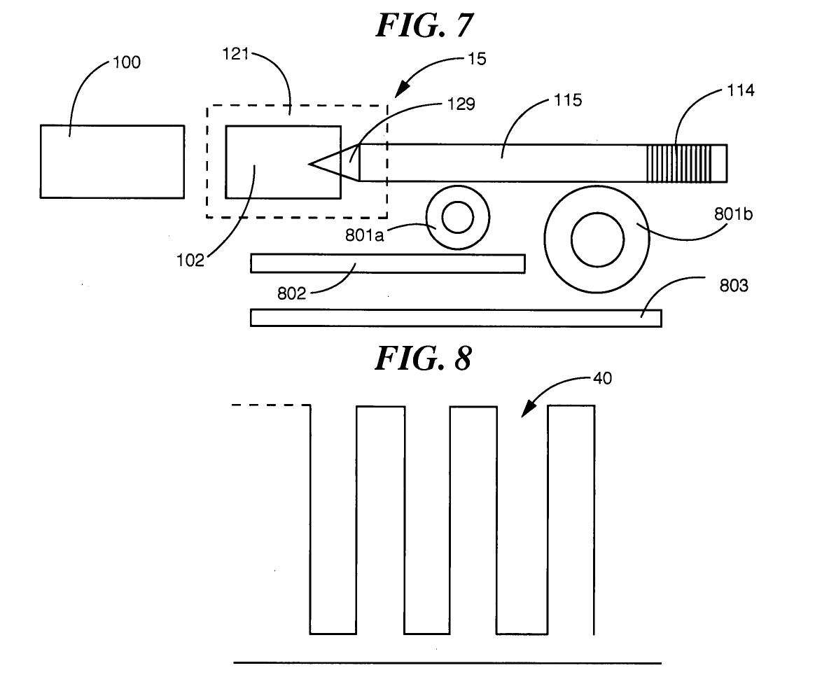

As shown in the embodiment of FIG. 7, an ECL system generally indicated as 15, utilizes non-like resonators. The ring resonators can be designed with different radii to couple different wavelength light into different waveguides. Again, like elements are identified with like numbers. The primary difference being the inclusion of different diameter resonators 801a, 801b, which are respectively, coupled to waveguides 802, 803. As a result, light traveling across HIC waveguide 115 will be optically coupled to either one of waveguides 802, 803, or no waveguide at all as a function of the wavelength of the light signal. Waveguides 802, 803, respectively, can be connected to a function block and/or an optional mode converter to an external fiber as described above.

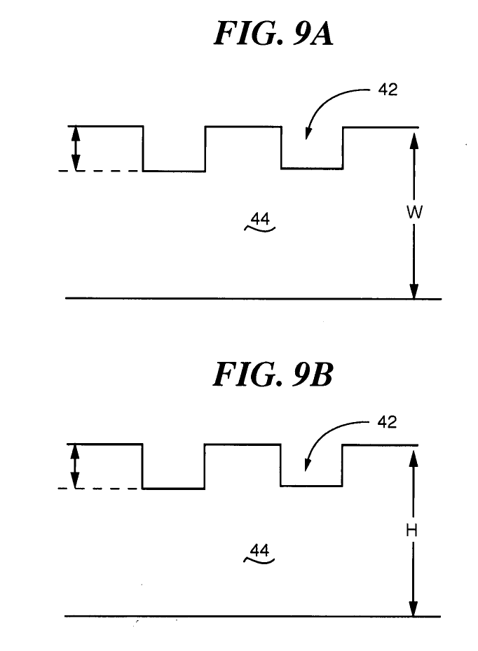

Since the narrow band filter is needed to make a single mode laser, the grating is preferred to be made on the lower index waveguide (e.g., fiber matched waveguide). When utilizing a low index contrast waveguide, a grating 40 can be deeply etched through as shown in FIG. 8. When utilizing a high index contrast waveguide, the bandwidth is wide. Therefore, a shallow etch grating is needed to form a narrow band filter as seen in FIG. 9 because a shallow etch 42 provides low effective index difference in the grating. Grating 42 can be either formed on a side of a waveguide core 44 or on top of a waveguide core as seen in FIG. 9A and FIG. 9B, respectively. These configurations allow the grating to be made on either high index or low index contrast waveguides.

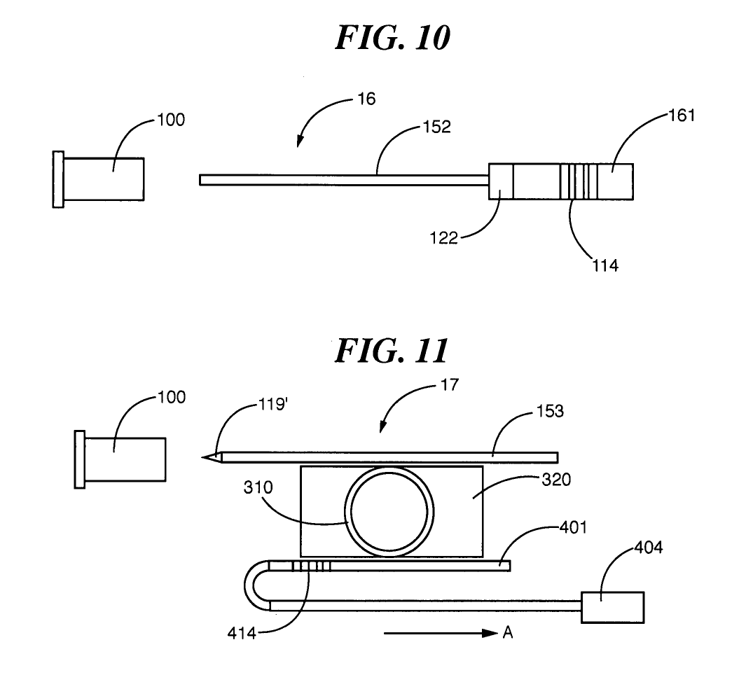

Reference is now made to FIG. 10 in which an ECL system, generally indicated as 16, utilizing the grating on a low index waveguide or fiber is provided. Again, like numerals are utilized for like structure. A gain medium 100, such as a laser, is optically coupled to an HIC waveguide 152, which is index matched to the output of the gain source 100. A low index waveguide fiber 161 or the like is optically coupled to HIC waveguide 152 utilizing mode converter 122. A grating 114 is provided on low index waveguide 161.

Where grating 114 is made on low index contrast waveguide 161, mode converter 122 is needed to couple light from high index waveguide 152 to low index contrast waveguide 161. In this particular embodiment, mode converter 122 is an integral part of the external cavity defined by grating 114 on low index contrast waveguide 161 and gain source 100.

Tunability for a laser is always a desired result. As shown in ECL system 16 (FIG. 11), a tunable external cavity laser may be achieved by putting a heating element on the region of a filter to change the filter characteristics. Again, like numerals are utilized to indicate like elements for facility of description. Tunable ECL 16 includes a gain source 100. Gain source 100 is optically coupled to an HIC waveguide 153 having a tapered laser coupler 119′ formed thereon at the signal receiving end thereof. A waveguide 401 having a grating 414 formed thereon is optically coupled to mode converter 404. The primary difference between system 16 and system 13 is that a resonator 310, which couples waveguide 153 to waveguide 401, is either integrally formed with or operatively connected to a heating element 320. As with system 13, grating 414 acts as the reflector for the cavity. Resonator 310 acts to optically couple light signals traveling through waveguide 153 to waveguide 401 of the selected wavelength as determined by the properties of resonator 310. Heating element 320 allows controlled change of the properties resonator 310 to change the wavelength of the light, which is selected out by resonator 310. Specifically, heating element 320 is able to change the refractive index of ring resonator 310, and this change will result in the shift of the reflection spectrum for grating 414. Thus, the wavelength of external cavity laser 16 is tuned.

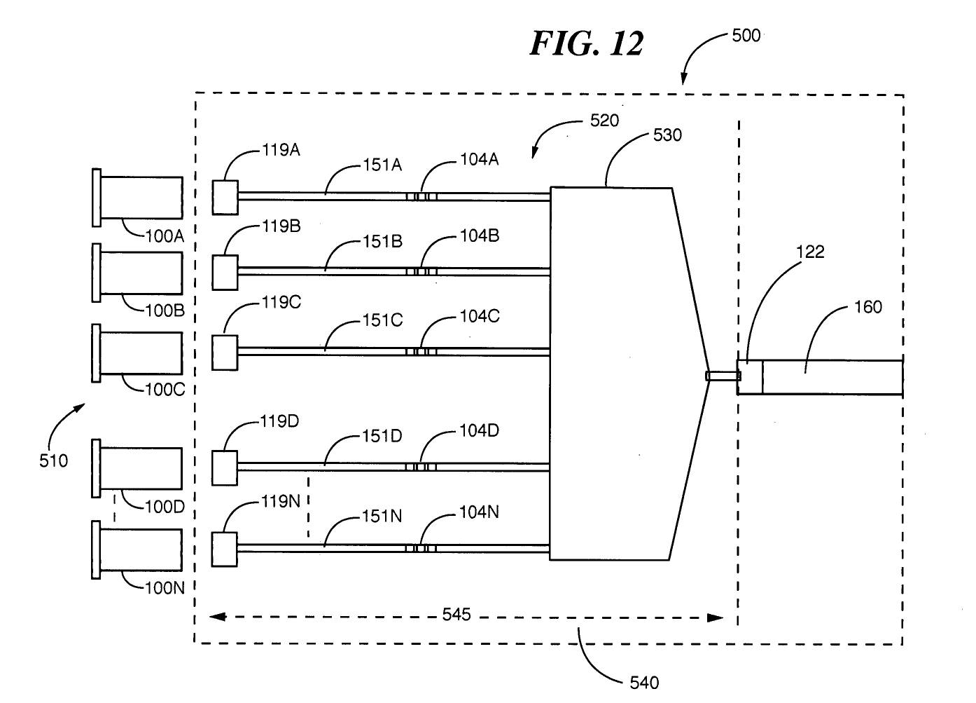

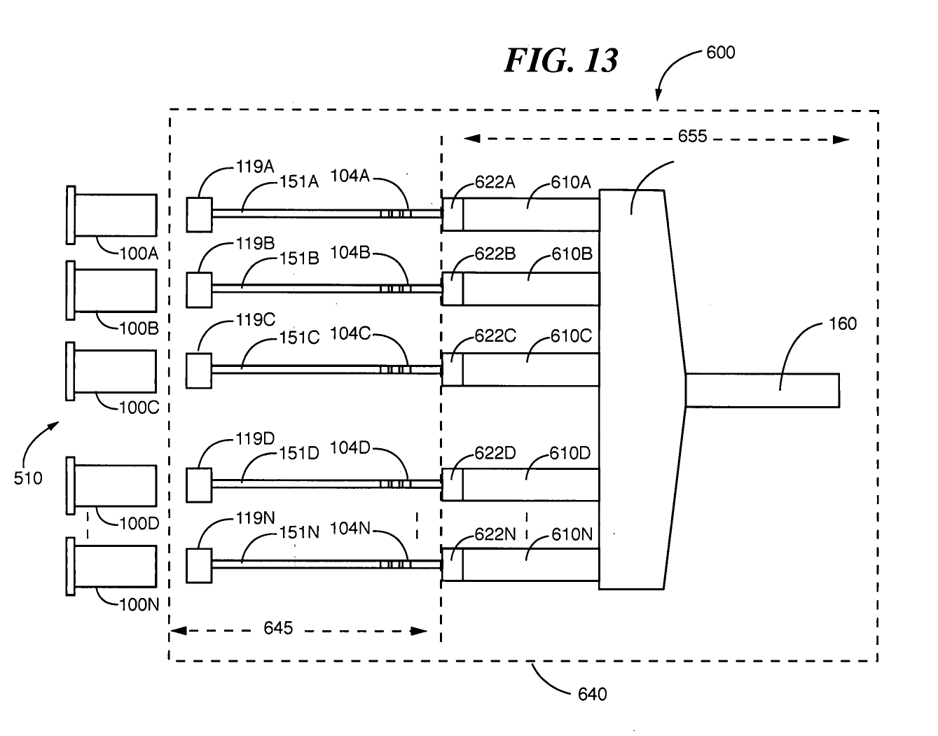

The external cavity laser presented in this invention may be formed in an array and integrated with a multiplexer to make an integrated wavelength division multiplexer (“WDM”) transmitter. Reference is now made to FIGS. 12 and 13 in which embodiments of a WDM transmitter constructed in accordance with the invention are shown. The integrated WDM transmitter includes a Fabry-Perot (F-P) laser array (e.g., gain source array), laser coupler, filter structure such as grating or ring resonator, and a multiplexer such as array waveguide grating or echelle grating. A WDM transmitter generally indicated as 500 includes an array of gain sources generally indicated as 510 formed by, by way of non-limiting example, F-P lasers 100. Similarly, an array of high index contrast (HIC) systems generally indicated as 520 providing input to a multiplexer 530 are provided. As discussed above, each system 520 includes a laser coupler 119A-N (collectively 119) at the receiving end of the respective HIC waveguide 151A-N (collectively 151). A respective filter 104A-104N (collectively 104) is provided on a respective waveguide 151A-N. As described above, filter 104 may be either a grating or a ring resonator. Each waveguide 151 provides an input to multiplexer 530. Multiplexer 530 provides an output to a mode converter 122 which is optically coupled to a fiber type matched waveguide 160.

In one embodiment as shown in FIG. 12, multiplexer 530 can be directly made on high index contrast waveguides 151A-N in which case only one mode converter is needed to couple the output of multiplexer 530 to fiber matched waveguide 160.

F-P laser array or gain source array 510 can be made either on the same III-V material chip, or on individual chips where different wavelengths are provided, or multiple chips where a band of wavelengths is covered by each chip. Furthermore, the multiplexer, waveguides and coupling structure may be formed by way of non-limiting example on a single Si chip 540. Furthermore, if desired, multiplexer 530, laser coupler 119 and waveguides 151 may be integrally formed in a high index region 545 of chip 540. When each filter structure is designed for each wavelength, a multiple channel single mode WDM laser array is formed, and all channels can be multiplexed into one waveguide. Then, by using a mode converter, all of the wavelengths are coupled into one low index contrast waveguide that usually has fiber matched index contrast. The advantage of this WDM transmitter based on external cavity laser is that multiple lasers are coupled into one fiber rather than the more traditional structure of multiple lasers coupled to multiple fibers.

As shown in FIG. 13, an embodiment of the invention similar to that of transmitter 500 is shown, the primary difference being the use of a low index contrast waveguide to incorporate the filter structure. In this case, multiple mode converters are necessary to couple each high index waveguide to the multiplexer. However, in this embodiment, as in transmitter 500, the filter is provided in the high index contrast region.

Specifically, a WDM transmitter 600 includes a gain source array 510 comprising respective gain sources 100A-100N (collectively 100), which in a preferred embodiment are F-P lasers. A respective laser 100 is optically coupled to respective HIC waveguide 151A-151N (collectively 151) through a respective laser coupler 119A-119N (collectively 119). A respective filter 104A-104N (collectively 104) is provided on each respective waveguide 151A-151N.

Each waveguide 151 provides an input to a respective low index contrast waveguide 610 through a respective mode converter 622A-622N. Respective waveguide 610A-610N provide an input to a multiplexer 630, which in turn provides an output to an index matched waveguide 160.

As with transmitter 500, transmitter 600 can be produced on a single SI chip 640. However, only laser coupler 119, waveguide 151 and filter 104 are fabricated within a high index contrast region 645 while mode converter 622, waveguide 610, multiplexer 630 and waveguide 160 are formed on a low index contrast region 655 of chip 640 in a preferred embodiment.

As in transmitter 500, filter 104 may take the form of either a grating or a ring resonator. This filter, in both transmitters 500, 600, is fabricated on the high index contrast waveguide 151 so that the ECL is formed within the high index contrast waveguide.

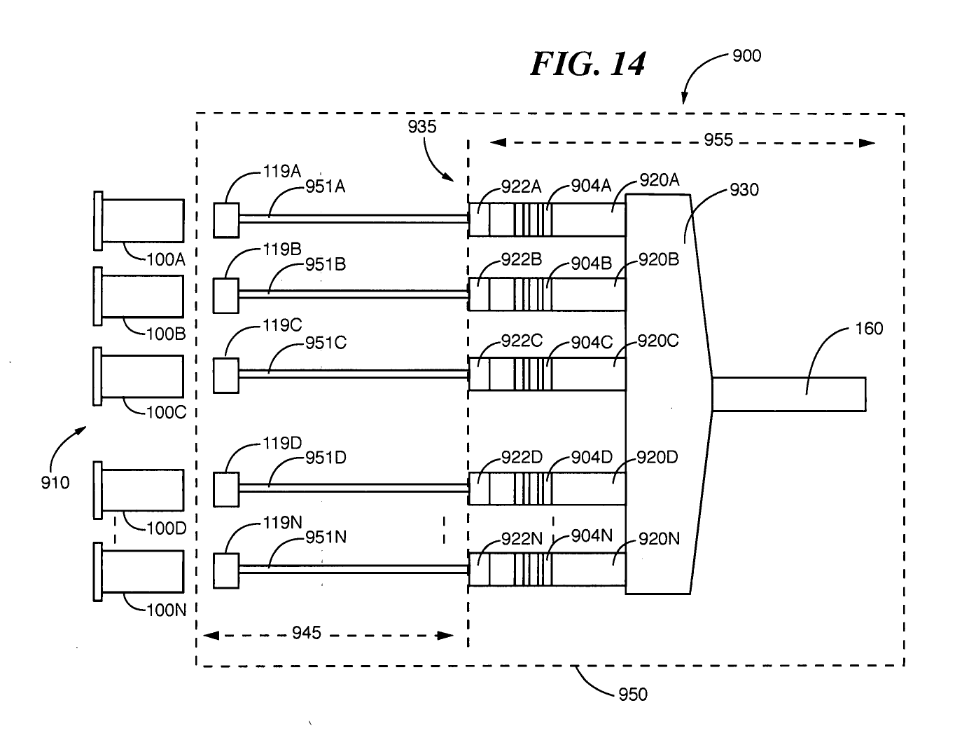

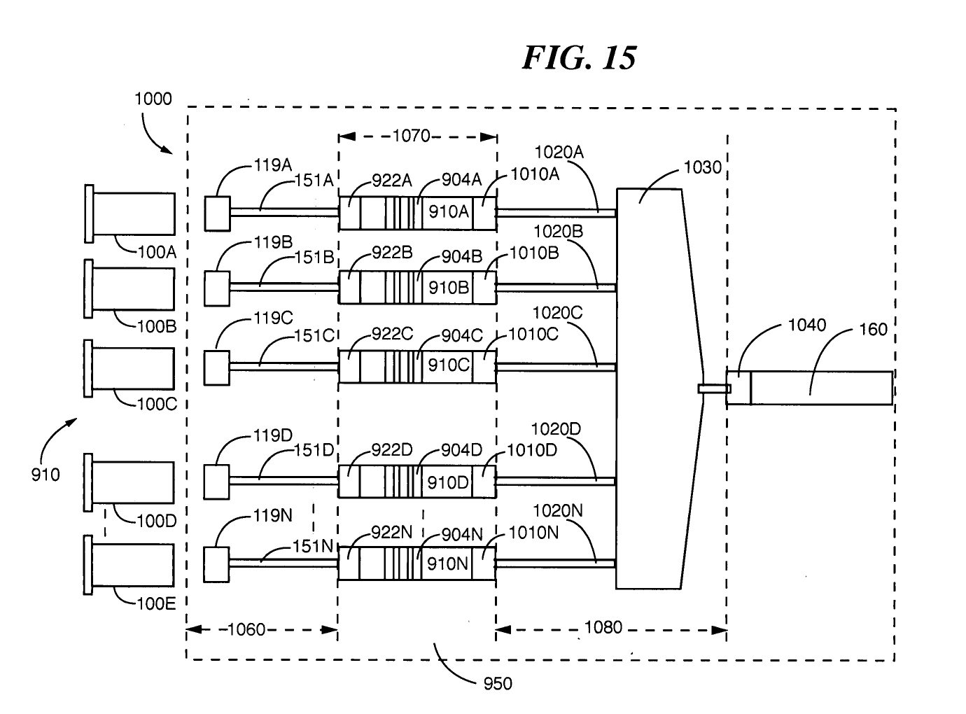

Without deviating from the spirit of the invention, variants of the described external cavity laser and integrated WDM transmitter are possible as shown in FIGS. 14 and 15. These variations, in addition to what have been described with respect to transmitters 500 and 600, may include the following configurations:

(1) Gain Source Array+ ECL in the low index contrast (“LIC”)

Waveguide+Mode Converter+Multiplexer in HIC waveguide+Mode Converter to Fiber

(2) Gain Source Array+ ECL in LIC Waveguide+Multiplexer in LIC waveguide to Fiber

Specifically turning to FIG. 14, a WDM transmitter generally indicated as 900, includes a gain source array 910, which in a preferred embodiment is an F-P laser array formed of respective laser diodes 100A-100N. Each is optically coupled to a respective laser coupler 119A-119N which is coupled to a respective HIC waveguide 951A-951N. The respective HIC waveguides (collectively 951) are input to a respective mode converter 922A-922N which provides an input to a respective low index contrast waveguide 920A-920N. A respective filter 904A-904N is formed on each low index contrast waveguide 920A-920N. Each waveguide (collectively 920) provides an input to a multiplexer 930, which in turn provides an output to a fiber matched waveguide 160.

In a preferred embodiment, high index contrast system 935 made up of the laser coupler, the HIC waveguide, the mode converter and low index contrast waveguide is formed on a single SI chip 950. Chip 950 includes a high index contrast region 945 and a low index contrast region 955. In this embodiment, the multiplexer 930 along with filter 904 is formed in the low index contrast region while only the laser coupler and HIC waveguide 151 are formed in the high index contrast region.

Reference is now made to FIG. 15 in which a WDM transmitter 1000 is provided. Transmitter 1000 is similar to transmitter 900, the primary difference being that the low index contrast structure is disposed between high index contrast structure. For simplicity of description, like numerals are utilized for like structure. In transmitter 1000, a respective HIC waveguide 151A-N provides an input to a low index contrast structure, which includes a respective mode converter 922A-N, and a second respective mode converter 101A-N formed at either end of a respective LIC waveguide 910A-910N. A respective filter 904, which may be either a grating or a ring resonator is formed on LIC waveguide 910. Each second mode converter 1010A-1010N is coupled to a respective HIC waveguide 1020A-1020N which in turn provides an input to a multiplexer 1030. Multiplexer 1030 provides an input to a mode converter 1040, which in turn is coupled to a fiber matched waveguide 160.

As with the other embodiments, the entire system, apart from the gain source array 910, may be formed on a single chip preferably made of silicon 950. Chip 950 is bifurcated or formed with a first high index contrast region 1060 and a second high index contrast region 1080. A low index contrast region 1070 is formed between first high index contrast region 1060 and second high index contrast region 1080. Mode converters 922, 1010 and the structure disposed therebetween are formed on low index contrast region 1070 while multiplexer 1030, HIC waveguide 1020 is formed in the second high index contrast region 1080 and laser coupler 119 and HIC waveguide 151 are formed in the first high index contrast region 1060.

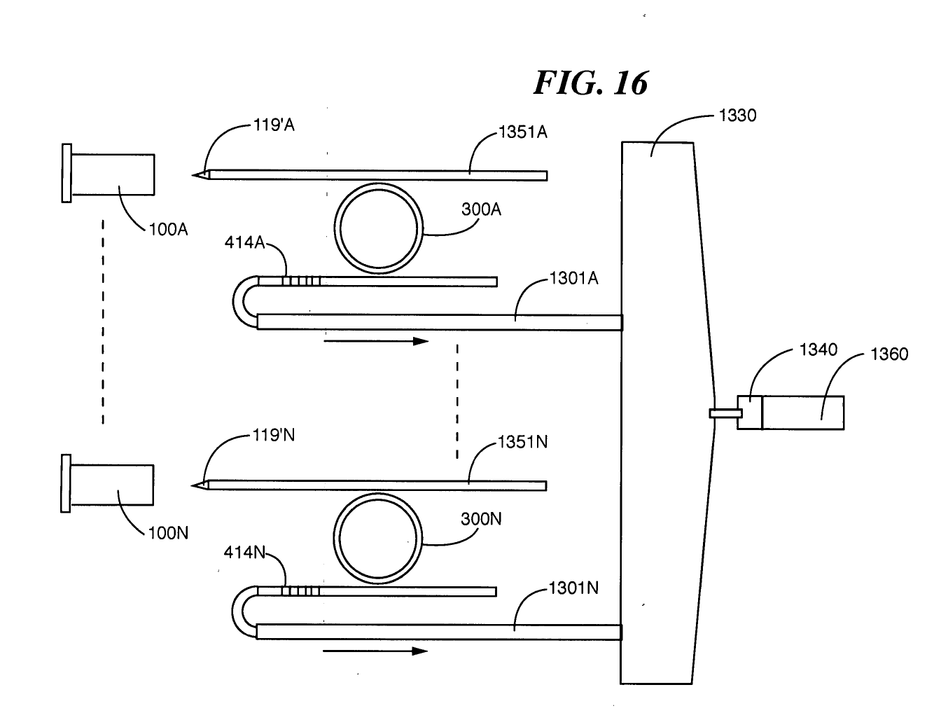

In another embodiment, the ring resonator based ECL as shown in FIG. 5 may be used as a building block and put in parallel to form an integrated WDM transmitter generally indicated as 950. Reference is made to FIG. 16 which shows such an embodiment where two ring resonator based ECL building blocks are shown. More building blocks can be put in parallel to form multiple ECLs connected to an input to the multiplexer. Like numerals are again used to identify like structures. In the transmitter 950, respective waveguides 1301A-1301N serve as an input to a multiplexer 1330. Respective ring resonators 1303A-1303N have different diameters to select different wavelengths. Multiplexer 1330 provides output to mode converter 1340 coupled to fiber matched waveguide 1360. Analogous to the WDM transmitters discussed above, utilizing a grating is shown, and various configurations may also be used for the ring resonator-based integrated WDM transmitter in the spirit of the invention. For instance, the multiplexer can be fabricated on low index contrast waveguide, in which case a mode converter is used to couple high index contrast waveguides 300A-300N to multiplexer 1330. In addition, a heating element as discussed above can also be used for the embodiment shown in FIG. 16 for wavelength tuning ability.

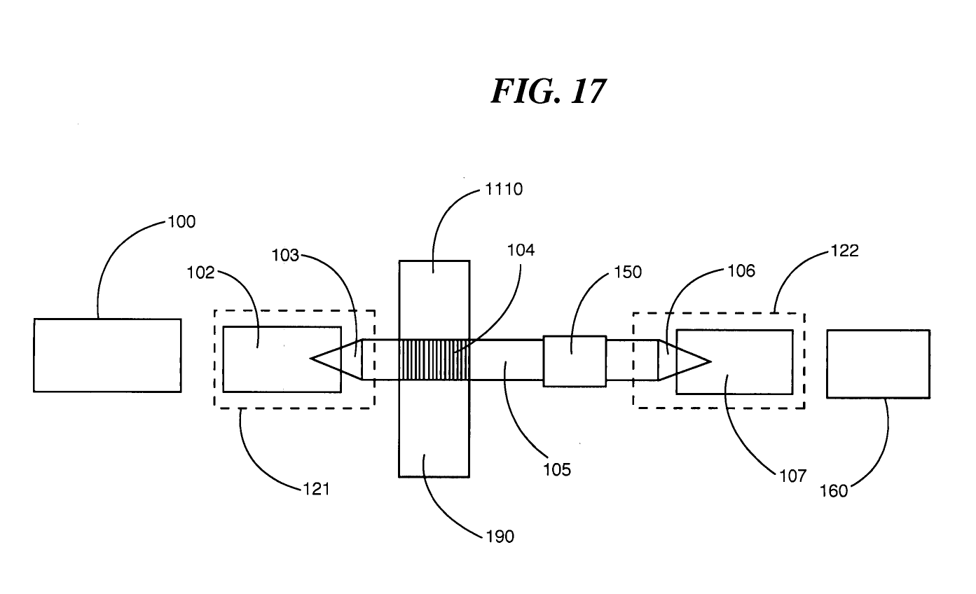

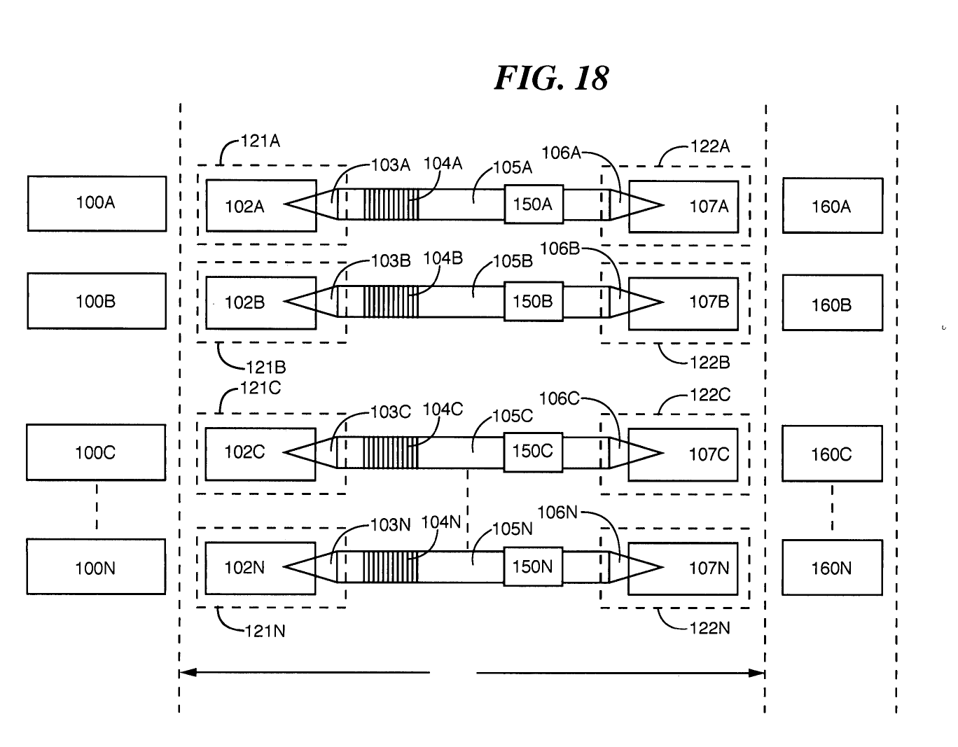

An extension to the basic configuration of the external cavity laser system 10 shown in FIG. 1 can be made to tune the laser. Reference is made to FIG. 17 in which an ECL generally indicated as 1100 is provided. Like elements are indicated with like numbers to facilitate discussion.

In tunable external cavity laser 1100, a heating element 190 is put on the region of grating 104. Heater 190 is able to change the refractive index of grating 104. The change will result in the shift of the reflection spectrum for grating 104, and then the wavelength of external cavity laser 1100 is tuned.

The structure of ECL 10 can be applied as the building block of a multiple laser array, where the multiple parallel waveguide structure which has a mode converter and grating and a high index waveguide. The array would consist of an array of respective gain sources 100A-100N optically coupled to a respective one of mode converters 121A-121N, each having the structure as discussed in connection with ECL 10. Similarly, each respective high index contrast waveguide system would include two mode converters 121, 122 coupling light from low index waveguides 102, 107 respectively. Each HIC waveguide 105A-105N having a respective grating 104A-104N thereon. The output of the high index contrast system being to a respective fiber or waveguide 160A-160N. The entire array may be formed as three distinct but internally integrated arrays such as a laser diode array for the gain source, a waveguide chip for the high index contrast system and a fiber array consisting of each fiber 160.

By carefully changing the dimension of grating, where each grating determines one wavelength, multiple wavelength laser arrays are realized. All the light consisting of different wavelengths are coupled into fiber array. Furthermore, the array may be tunable by incorporating a heating element for each grating 104 as discussed above.

Furthermore, additional functional blocks, such as filters, gratings, tuning elements, couplers, splitters, modulators, attenuators, and amplifiers can be integrated with the external cavity laser described in this invention to enhance device functionality and performance without deviating the spirit of the invention.

In another embodiment of the invention, an external gain element is integrated with a high index waveguide system: a gain clamped linear optical amplifier embodiment of the invention. One aspect of the present invention is directed to a gain clamped linear optical amplifier having a constant gain independent of the input power and the number of input WDM channels, which provides great flexibility and reliability to an optical network. According to one embodiment of this invention, the low cost gain clamped optical amplifier uses an External Cavity Laser (“ECL”) structure which comprises of an active gain medium, one or more mode converters for the light coupling between the gain element and the external cavity waveguide, one or more mode converters for coupling between the ECL and an output fiber or (fiber matched) waveguide, a high or low index contrast waveguide structure and a filter structure fabricated either on high or low index contrast waveguide.

The laser light whose wavelength is defined by the filter transmission peak of the ECL will clamp the gain value of the active gain medium at a constant value that is substantially at equilibrium with the loss through external cavity. By selecting the lasing wavelength near the edge of the gain bandwidth, almost all the gain bandwidth can be utilized for a linear amplification. The operating current of the ECL determines the maximum linear input power. When the operating current of the ECL is well above the threshold current, we can obtain a wide dynamic range of linear amplification, having enough high maximum linear input power.

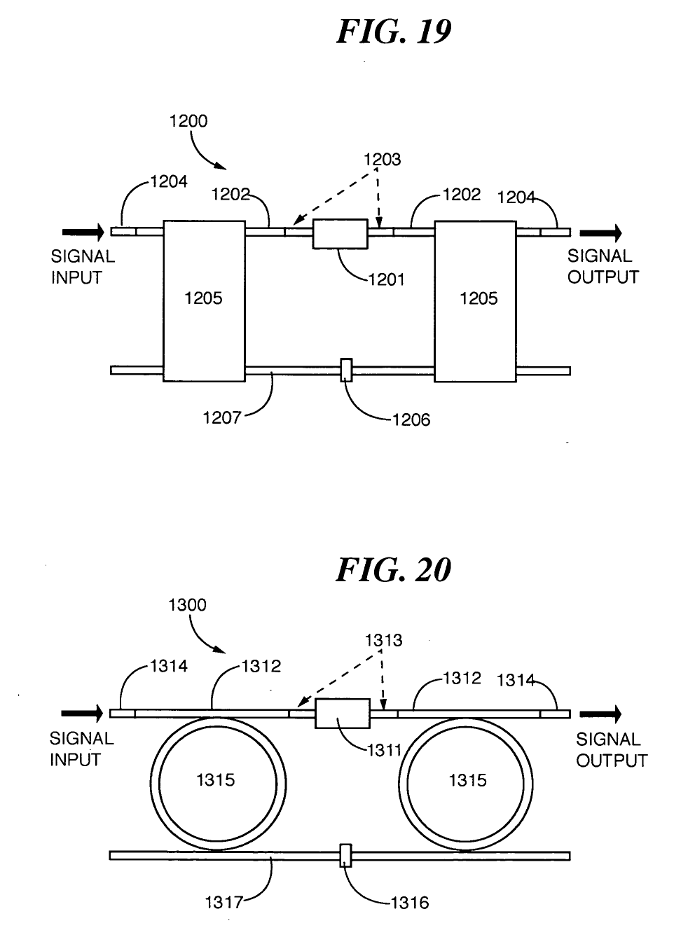

Referring now to drawings in detail, reference is made to FIG. 19 in which a schematic top plan view of a gain clamped linear optical amplifier, generally indicated as 1200, is provided. Amplifier 1200 includes a gain medium 1201, high index contrast waveguides (HIC-WG) 1202, mode converters 1203 for coupling light between gain medium 1201 and HIC-WG 1202, mode converters 1204 for coupling light between respective HIC-WG 1202 and fiber matched low index contrast waveguides (LIC-WG), narrow band 4 port filter 1205 built with HIC-WGs. Although a variable optical attenuator (optional) 1206 may be built on or connected to an HIC-WG 1207, which is coupled to filters 1205,. In one embodiment, gain medium 1201 is based on III-V materials and is a semiconductor optical amplifier (SOA). In the preferred embodiment, with the exception of gain medium 1201, all the structures (functionalities) are monolithically integrated on a silicon substrate and hybrid integrated with gain medium 1201. Standard CMOS compatible fabrication processes are used for the monolithic integration on the silicon-based material platform, and this allows for the low cost solution.

The external laser cavity is formed by gain medium 1201, narrow band 4 port filter 1205, and waveguide 1207, waveguide 1207 clamps the gain of gain medium 1201 in such a way that the gain exactly compensates the loss of the laser cavity. Gain medium 1201 may require anti-reflection (AR) coating to prevent build up of a laser cavity inside the gain medium 1201. In one embodiment, gain medium 1201 may be formed as a Semiconductor Optical Amplifier (“SOA”), and for the rest of the description as an illustration purpose, the term “SOA” instead of “gain medium” will be used interchangeably without limiting the gain medium to be an SOA.

The coupling between the SOA/gain medium 1201 and waveguide or fiber is usually a big issue, and leads to a high noise figure of the SOA 1201. To overcome this difficulty, it is known in the art to taper gain medium together with some specialty fiber to improve the coupling. However, the coupling is inefficient. In the present invention, two types of specially designed mode converters are used. First, the mode converting technology as disclosed in U.S. patent application Ser. Nos. 09/841,464 and 09/978,310 owned by LNL Technologies, Inc. is used for the mode converter 1204 to efficiently couple HIC-WG 1202 and fiber or fiber matched LIC-WG (not explicitly shown in the figure). Other mode converter designs as known in the art may be used for mode converter 1203 to dramatically reduce the coupling loss between SOA 1201 and HIC-WG 1202. These two specially designed mode converters are the key elements for cost reduction since they make possible the high efficiency hybrid integration and fiber coupling.

Variable Optical Attenuator (VOA) 1206 can be used to change the loss of the laser cavity and to correspondingly change the gain value of the amplifier. Narrow band 4 port filter HIC-WGs 1205 select the wavelength of the lasing mode, and the lasing wavelength can be tuned by tuning these filters by, in one embodiment, using a heating element (not shown, but described above) put in the region of 1205. By selecting the lasing wavelength near the edge of the gain bandwidth, most of the gain bandwidth can be utilized for a linear amplification.

The description above for amplifier 1200 is based on the use of HIC-WG for the external cavity. As in another embodiment, low index contrast waveguide (LIC-WG) or a combination of HIC-WG and LIC-WG may be used for the external cavity within the spirit of the present invention.

It is further possible, as demonstrated above, to form filters 1205 as ring resonators. Reference is now made to FIG. 20 in which a ring resonator filter is utilized for the narrow band four-port filter. An amplifier 1300 includes a gain medium 1311 having mode converters 1313 optically coupled on either side thereof. Respective optical couplers 1313 are disposed and optically coupled to high index contrast waveguides 1312. As in amplifier 1200, HIC waveguides 1312 are optically coupled to a respective input signal and output signal by respective mode converters 1314. An HIC WG 1317 is provided, and, as above, although not necessary for the function of the invention, a variable optical attenuator 1316 may be disposed along waveguide 1317. The operation of these respective components is similar to that of their counterparts in laser 1200. The primary difference being the use of ring resonators 1315 as the filter in place of filters 1205. Resonators 1315 may select signals input as a function of their resonant characteristics, which may be set by resonator diameter, as well as by tuning the resonator utilizing a heating element or an electrical input.

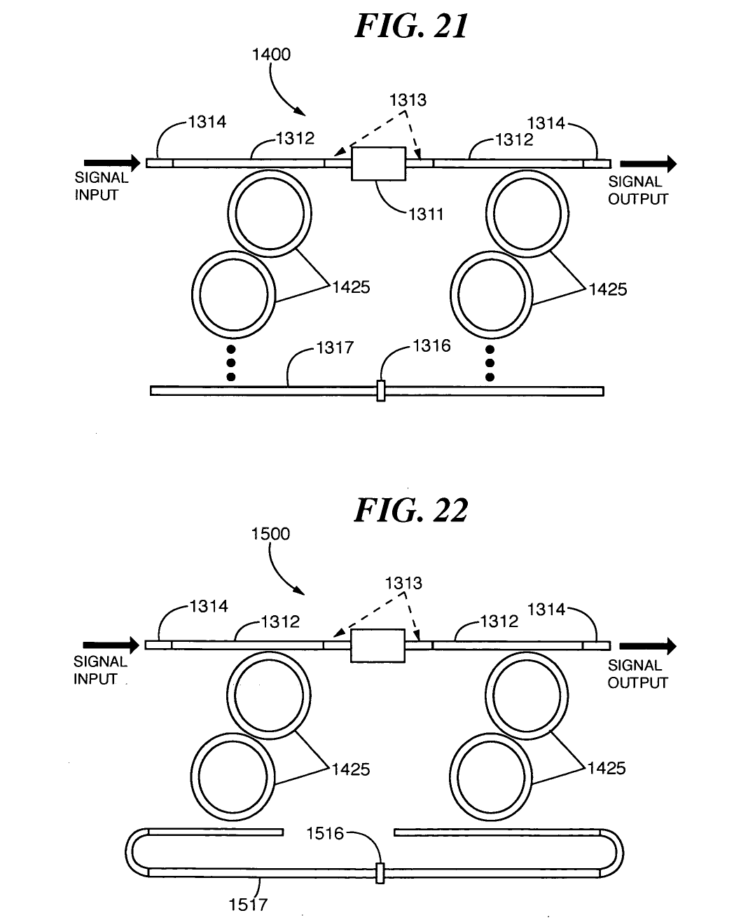

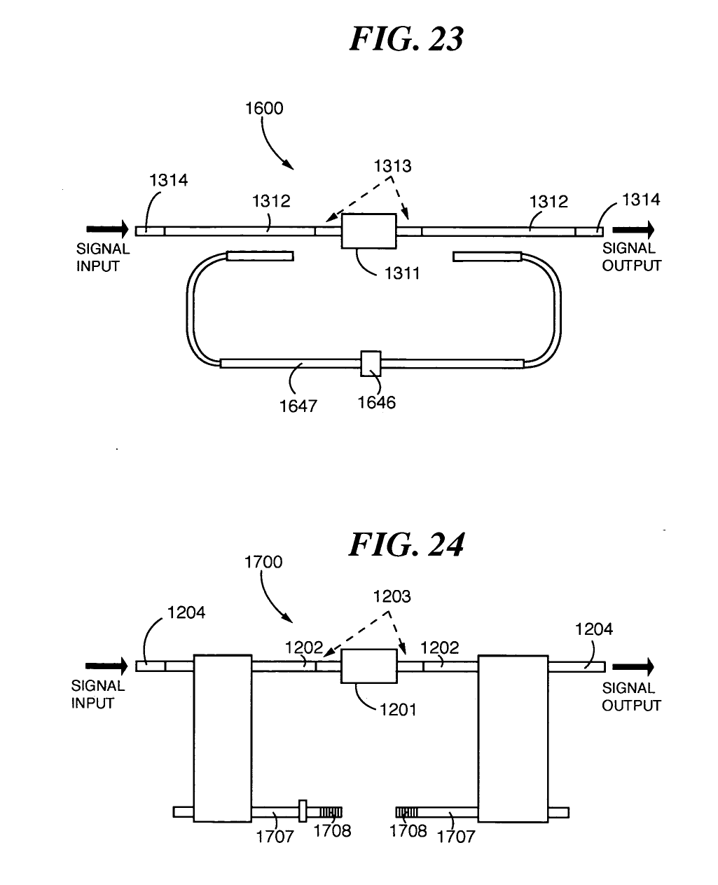

Reference is now made to FIG. 21 in which a laser 1400 having a higher order ring resonator filter is provided. The primary difference between laser 1400 and laser 1300 being the use of higher order ring resonators as the filter therefore. Again, like numerals are utilized to indicate like structure for ease of description. As with laser 1300, laser 1400 includes a gain medium 1311 optically connected on either facet by mode converters 1313. Respective HIC waveguides are optically coupled to a respective one of mode converters 1313 and to respective second mode converter 1314 which in turn is connected to a signal input waveguide or signal output waveguide. A HIC waveguide 1317 is optically coupled to HIC waveguide 1312 through higher order (multi-ring) filters 1425. Again, an optical attenuator 1326 may be disposed, although not necessary for performance of the invention, along HIC waveguide 1317. By using higher order ring resonator as the narrow band four-port filters, finer filter wet filtering may be provided. It should be noted that either an even or odd number of ring filters may be used and waveguide 1317, with the optional VOA 1316 may be shaped to guide light waves in a correct direction to form an external cavity.

Reference is now made to FIG. 22 in which a further embodiment where the high index contrast waveguide, which forms the cavity, is formed as a racetrack configuration. Again, like numerals are utilized to indicate like structure, the primary difference being the configuration of the HIC waveguide acting as part of the external cavity. In this embodiment, HIC waveguide 1517 is shaped as an incomplete racetrack configuration. Furthermore, in this embodiment, it is preferred that the number of ring resonators 1425 be even.

It is well known in the art that the properties of the ring filters, such as bandwidth and center wavelength, can be accurately controlled, and especially the center wavelength and peak transmission can be tuned after fabrication. Without deviating from the scope of the present invention, “race track” shaped ring filters, in addition to circular ones as shown in the figures described so far, can be used as a narrow band four port filter.

Reference is now made to FIG. 23 in which another embodiment of an external cavity laser amplifier having a directional coupler is shown. Again, like numerals are utilized to indicate like structure. An external cavity laser amplifier, generally indicated as 1600 includes a C-shaped or open racetrack HIC waveguide 1647 with a filter 1646 disposed thereon. A small amount, typically 5-10%, of wave signal from the SOA 1311 is directionally coupled to the waveguide 1647 and a specific wavelength, filtered using the filter 1646, clamps the gain of the amplifier. An optional VOA on waveguide 1647 can be used even though explicitly not shown.

Reference is now made to FIG. 22 in which an external cavity laser amplifier utilizing a discontinuous waveguide with waveguide gratings forming an external cavity is provided. The external cavity of a laser amplifier generally indicated as 1700 in this embodiment is similar to laser amplifier 1200 discussed above with like numerals being utilized to indicate like structure. The primary difference being the use of a discontinuous HIC waveguide. HIC waveguide 1707 is a discontinuous HIC waveguide being optically connected to a respective narrow band 4 port filter 1205. At each respective end of each waveguide 1707 a grating 1708 is formed in facing relationship across a gap g. Each grating 1208 works as a reflector or as a filter of a wavelength that is the same resonant wavelength as the wavelength determined by the narrow band 4 port filter 1205. An Optional VOA 1706 is used to change the loss in the cavity and correspondingly tune the gain of the amplifier.

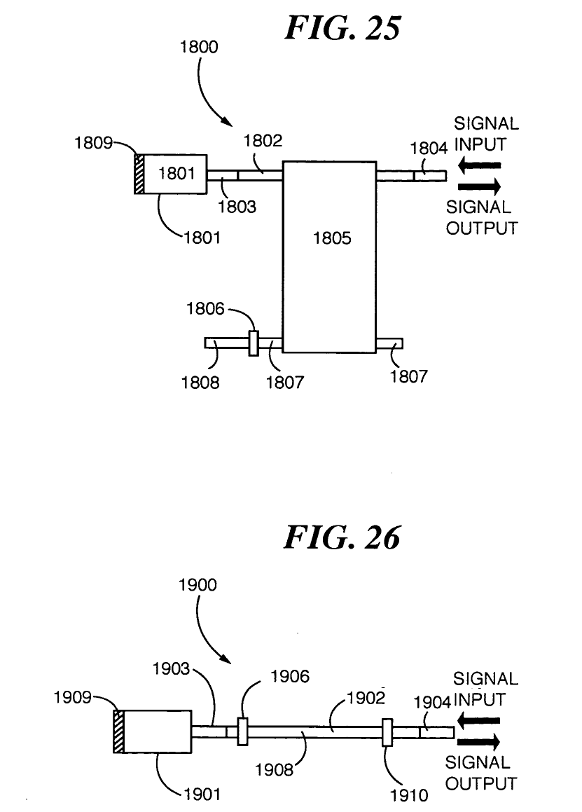

Other external cavity laser amplifier configurations are possible in accordance with the invention. Reference is made to FIG. 25 in which an ECL, generally indicated as 1800 is provided. ECL 1800 includes a narrow band 4 port filter 1805. An HIC waveguide 1807 is provided as two ports of filter 1805. A gain medium 1801, an SOA by way of non-limiting example, has a reflecting surface 1809 at one facet. A mode converter 1803 is provided at the opposed facet and is optically coupled to filter 1805 by HIC waveguide 1802. As a result, a waveguide grating 1808, formed on waveguide 1807, is optically coupled to filter 1805 on one side of the SOA 1801, while reflecting surface 1809 is located at the opposite side of the SOA 1801. The reflecting surface, such as a mirror can be fabricated by metalization. One type of mode converter 1803 is used to couple the SOA 1801 and HIC-WG 1802, and another type of mode converter 1804 is used to couple HIC-WG 1802 and a fiber/fiber matched LIC-WG (not shown) at the laser output. An advantage of this configuration is that one side alignment for hybrid integration is much easier than two side alignment as previously indicated in laser 1700 by way of example. Another advantage is using one location for input and output signals. One drawback might be an additional process step required to build the reflecting surface 1809 on the other side of SOA 1801. A VOA 1806 may be provided on waveguide 1807.

Another exemplary configuration of an external cavity laser amplifier generally indicated as 1900 is shown in FIG. 26. Laser amplifier 1900 includes a gain medium 1901, such as by way of non-limiting example an SOA, having a reflective surface 1909 on one facet and being coupled to a mode converter 1903 at its opposite facet. A high index contrast waveguide 1902 is optically coupled to mode converter 1903. A grating 1908 is formed along waveguide 1902. Grating 1908 reflects and selects a specific wavelength that is used to clamp the gain of SOA 1901. If necessary, an additional filter 1910, a 2 port filter, can form the external cavity to reduce filter width without a narrow band 4 port filter. Similar to amplifier 1800, a reflecting surface 1909 is required for SOA 1901, and the same port is used for input and output signals. Also, mode converters 1903 and 1904 are used to couple light between the SOA 1901 and waveguide 1902, and between the waveguide 1902 and an external fiber matched waveguide, respectively. An optional VOA 1906 may be used as well.

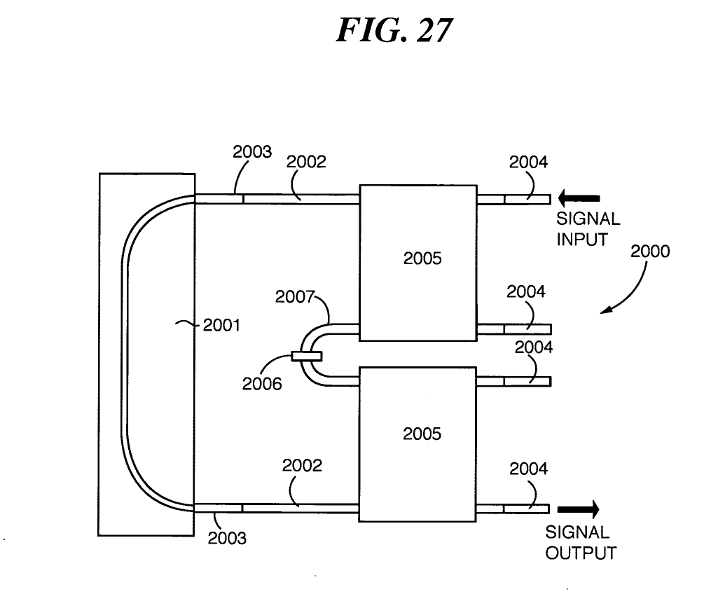

Reference is now made to FIG. 27 in which another exemplary embodiment of an external cavity laser amplifier, generally indicated as 2000, is provided. Amplifier 2000 includes an SOA 2001 having both input and output port on the same facet and being coupled to a narrow band 4 port filter 2005, allowing a hybrid integration with an alignment only on one side of the SOA 2001. Each of the input and output of SOA 2001 is optically coupled to a respective mode converter 2003. Each mode converter 2003 is optically connected to a respective waveguide 2002 which in turn provides either an input to or an output from a respective 4 port narrow bandwidth filter 2005. Each filter 2005 has ports which cooperate with either an external waveguide or fiber optically coupled to said waveguide or fiber by a respective mode converter 2004. Each of filters 2005 is coupled to each other by a high index contrast waveguide 2007. An optional VOA 2006 may be provided along waveguide 2007.

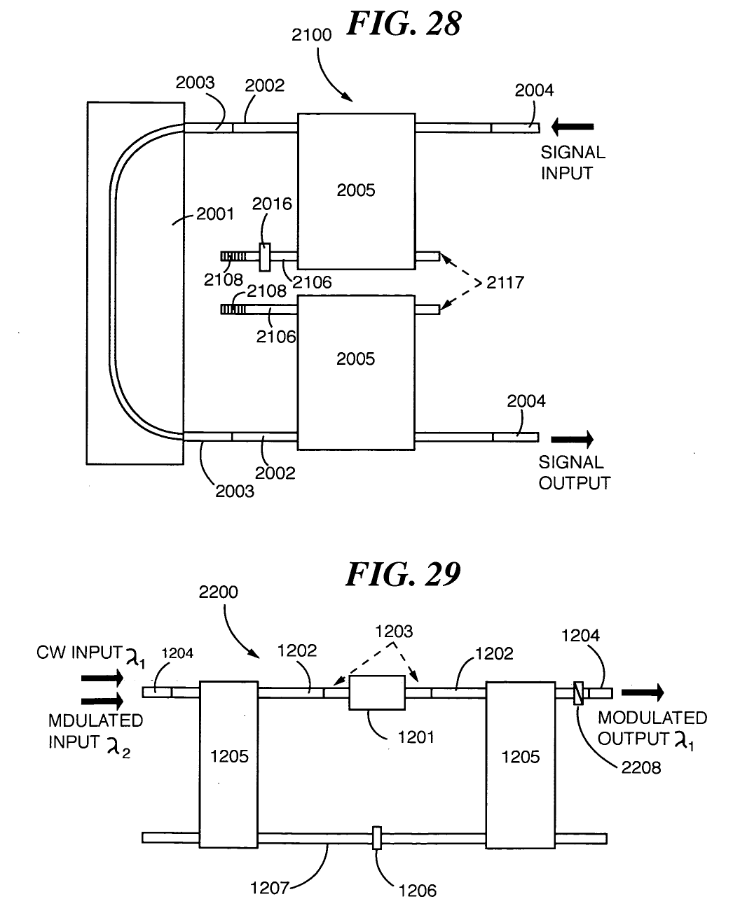

Reference is now made to FIG. 28 in which another embodiment of a laser amplifier generally indicated as 2100 is provided. This embodiment is similar to laser amplifier 2000, the primary difference being the provision of gratings at at least one port of each filter 2005 rather than optically coupling the filters with each other. Again, like terms are utilized to indicate like structure. Each of filters 2005 has a first port with a respective waveguide 2106 with a respective grating 2108 provided thereon. The remaining output is a HIC waveguide 2117. An optional VOA 2016 may be provided on at least one of waveguides 2016.

The gain clamped linear optical amplifier of the invention can be utilized as a wavelength converter. When the input power exceeds the maximum linear input power, the carrier concentration of the active medium changes inducing the refractive index change according to the Kramers-Kronig relation. In this operation regime, the refractive index modulation caused by the input power variation results in the phase modulation of the local cw (continuous wave) signal, and this phase modulated cw signal transforms into the intensity modulated signal by using an additional interferometer. The modulation information of the input signal is transformed into the local cw signal whose wavelength is the target wavelength of the wavelength conversion. By carefully determining the power level of the input signal and the local cw signal, and the operating current, efficiency and dynamic range of the wavelength conversion are optimized.

One exemplary embodiment of a wavelength converter is shown in FIG. 29, in which a wavelength converter, generally indicated as 2200, is provided. Converter 2200 utilizes the external cavity laser amplifier configuration of laser 1200 and for ease of description, like elements are indicated with like numbers. In this embodiment, a narrow band 4 port filter 1205 has a lasing wavelength of λ₀. A modulated input wavelength λ₂ is converted into wavelength λ₁ which is the wavelength of the local CW input light. To block any residual wavelength λ₂ at the output, a band-pass filter 2208 may be used.

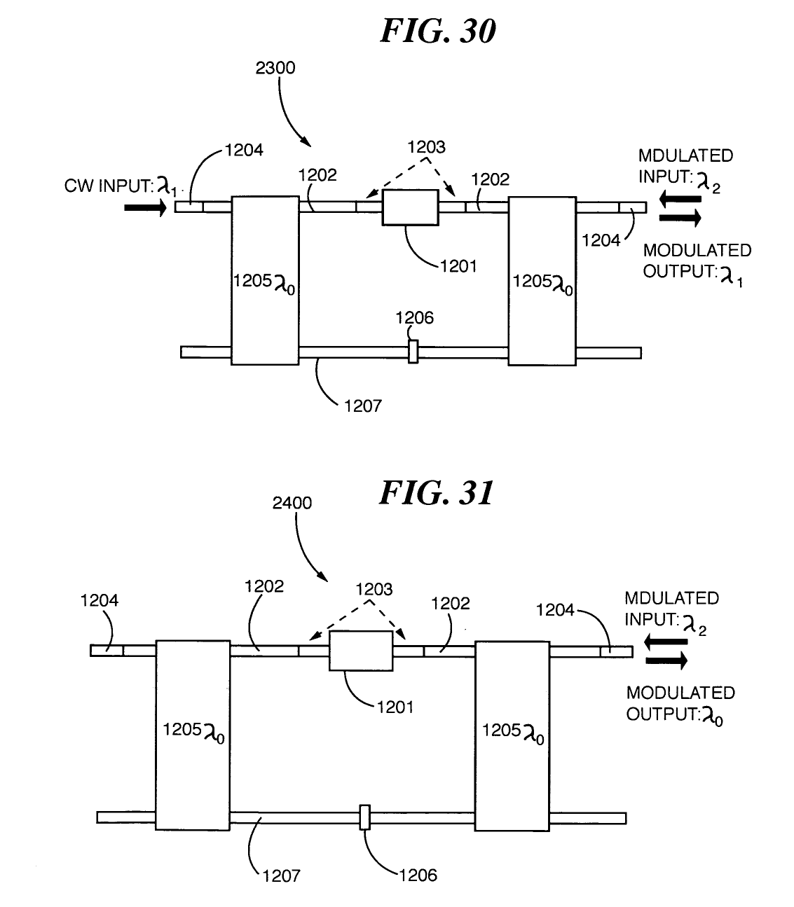

When the modulated input wavelength λ₂ is output from the output port in the reverse direction, a band pass filter at the output port is not required as shown in converter 2300 (FIG. 30). The phase modulated output at wavelength λ₁ is then transformed into an intensity modulated signal by using an additional interferometer. Again, like numerals are utilized to indicate like structure, the primary difference being the removal of the band pass filter and the direction of signal inputs.

The wavelength conversion can also be implemented by using XGM (cross gain modulation). When the laser is close to the threshold operation regime, the laser light is turned off when there is an input signal. This then becomes the wavelength conversion from the input signal to the laser signal of the ECL. To change the target wavelength, the lasing wavelength should be changed by changing the associated filter transmission wavelength.

FIG. 31 shows a top view of an exemplary embodiment of a wavelength converter, generally indicated as converter 2300 using XGM.

Converter 2400 is identical in structure to laser 1200, however, the processing of signals is different. Like numerals are utilized to identify like structure. A modulated input wavelength λ₂ is converted into λ₀ which is the wavelength of the external cavity laser determined by a narrow band 4 port filter 1205. The target wavelength λ₀ can be changed by tuning the filter transmission wavelength of the laser. Without deviating from the spirit of the present invention, other external cavity configurations as described earlier can be used as a wavelength converter using either CW modulated signal or XGM.

Thus, while there have been shown, describe and pointed out novel features of the present invention as applied to preferred embodiments thereof, it will be understood that various omissions and substitutions and changing the form and details of the disclosed invention may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention, which, as a matter of language, might be said to fall there between.

What is claimed is:

1. A optical module comprising at least one gain element and one optical element, said optical element having at least one high index contrast waveguide and at least one mode converter optically connecting said at least one high index contrast waveguide to an external fiber, wherein said at least one mode converter and said at least one high index contrast waveguide are monolithically integrated with each other.

2. The optical module of claim 1, further comprising a second mode converter, said second mode converter optically connecting said at least one high index contrast waveguide to the at least one gain element; said second mode converter and said high index contrast waveguide are monolithically integrated with each other.

3. The optical module of claim 2, wherein said second mode converter includes a tapered tip formed on said at least one high index contrast waveguide.

4. The optical module of claim 3, wherein said tapered tip is one of adiabatic and linear.

5. The optical module of claim 3, wherein said tapered tip is oriented towards said gain medium.

6. The optical module of claim 1, wherein said at least one high index contrast waveguide is optically connected to the at least one gain element, and said at least one of said high index contrast waveguide is mode matched to said gain element.

7. The optical module of claim 1, wherein said at least one high index contrast waveguide is optically connected to at least one grating to form an external cavity laser.

8. The optical module of claim 7, further comprising at least one low index waveguide optically connected to said at least one high index waveguide, wherein the at least one grating is formed on the at least one low index contrast waveguide.

9. The optical module of claim 7, further comprising an at least one second mode converter, the at least one second mode converter being optically coupled between the at least one low index contrast waveguide and at least one high index contrast waveguide.

10. The optical module of claim 1, further comprising at least one filter for wavelength selection, the at least one filter being formed on said at least one high index contrast waveguide to form an external cavity laser.

11. The optical module of claim 10, wherein said at least one filter includes at least one ring resonator.

12. The optical module of claim 11, wherein said at least one ring resonator is tunable to provide wavelength tuning of the external cavity laser.

13. The optical module of claim 1, wherein the at least one gain element consists of multiple gain regions, and a respective corresponding at least one mode converter being optically connected between a respective gain region and a respective corresponding at least one high index contrast waveguide.

14. The optical module of claim 13, wherein said each of said respective gain regions is locked to a respective different wavelength to form a WDM transmitter.

15. The optical module of claim 14, further comprising a multiplexer optically coupled to each of said at least one high index contrast waveguide, wherein said multiplexer multiplies the respective different wavelengths, said multiplexer being monolithically integrated to said optical element.

16. The optical module of claim 1, wherein the optical element further comprises at least one filter optically connected to said high index contrast waveguide, a filtered wavelength of said filter being a lasing wavelength of said at least one gain element to clamp a constant gain of said at least one gain element to produce a constant gain in an output signal of said optical module.

17. The optical module of claim 16, wherein said optical module is an amplifier and said amplifier is biased well above a threshold so that a gain of said at least one gain element is substantially at equilibrium with a loss through an external cavity formed by said filter and gain medium.

18. The optical module of claim 16, wherein said at least one filter includes at least one ring resonator formed on said high index contrast waveguide.

19. The optical module of claim 16, wherein at least one of said at least one filter includes at least one grating.

20. The optical module of claim 1, wherein said optical module is a wavelength converter.

21. The optical module of claim 20, wherein said gain element is biased at at least a threshold, so that an input at a predetermined wavelength is converted to an output of a different wavelength.

22. The wavelength converter of claim 20, further comprising a respective input port to each of said at least one gain element, and a respective output port from each of said at least one gain element, wherein a continuous wave input having a wavelength λ₁ and a modulated input having a wavelength λ₂ are input at said input port of said gain element, and a modulated output at said output has a wavelength λ₁.

23. The wavelength converter of claim 22, wherein modulated input of wavelength λ₂ is converted by cross gain modulation to a modulated output at a lasing wavelength of said amplifier without the use of a continuous wave signal.
